(19) United States
(12) Patent Application Publication
(10) Pub. No.: US 2026/0230581 A1
(43) Pub. Date: Aug. 6, 2026

(54) CONCEALING BACKGROUND INTERRUPTIONS DURING A VIDEO COMMUNICATION SESSION IN AN ELECTRONIC DEVICE

(71) Applicant: MOTOROLA MOBILITY LLC, WILMINGTON, DE (US)

(72) Inventors: RANJEET GUPTA, Aurora, IL (US); RAHUL Bharat DESAI, Hoffman Estates, IL (US)

(21) Appl. No.: 19/046,637

(22) Filed: Feb. 6, 2025

(51) Int. Cl. H04N 7/15; G06V 10/74; G06V 20/52; G06V 40/16; H04N 7/14

(52) U.S. Cl. CPC H04N 7/152; G06V 10/761; G06V 20/52; G06V 40/174; H04N 7/147

(57) ABSTRACT

An electronic device, a method and a computer program product for monitoring a background of a live video and replacing the live video with a previously recorded video clip. The method includes, while an electronic device is providing a live video to a video communication session using a camera, detecting a change in a background area adjacent to a background of the live video. The change includes an element that would present a visual distraction to other participants of the video communication session. In response to detecting the change, the method includes stopping presentation of the live video to the video communication session. The method includes retrieving a pre-recorded video clip of a local participant of the video communication session. The local participant is captured within the live video. The method includes presenting the pre-recorded video clip in place of the live video to the video communication session.

### BACKGROUND

### 1. Technical Field

The present disclosure generally relates to electronic devices and in particular to electronic devices that enable video communication sessions.

### 2. Description of the Related Art

Electronic devices, such as mobile phones, tablets, and laptops, are widely used for video, voice, and text communication and for data transmission. Many conventional electronic devices have at least one front facing camera and one or more rear facing cameras, along with one more display devices. Electronic devices with cameras can be used to conduct video communication sessions with one or more other electronic devices. Video communication sessions can also be referred to as a video call or a video conference. In today's telecommuting work environment, many people join important video conferences from home or other locations that may be susceptible to background interruptions, which can be distracting to the other participants on the video call/conference.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices and several image capturing devices, according to one or more embodiments;

FIG. 1C is an example illustration of the front of an electronic device with a front display and multiple front cameras, according to one or more embodiments;

FIG. 1D is an example illustration of the rear of an electronic device with a rear display and multiple rear cameras, according to one or more embodiments;

FIG. 2 is an example block diagram of a video communication session environment, according to one or more embodiments;

FIG. 3 is a block diagram of example contents of the memory subsystem of the example electronic device of FIG. 1A-1B (FIG. 1), which are utilized by and within the electronic device to complete the various processes described herein, according to one or more embodiments;

FIG. 4 illustrates an example electronic device being used during a video communication session to capture a live video of a local participant of the video communication session, according to one or more embodiments;

FIG. 5A illustrates an example video stream of a local participant in a video communication session captured within a field of view of a first camera of the electronic device, according to one or more embodiments;

FIG. 5B illustrates an example of the video stream of the local participant of FIG. 5A with a child entering the FOV and visible in the background, and potentially presenting a visual distraction to other participants of the video communication session, according to one or more embodiments;

FIG. 6A illustrates an example replacement video stream of the local participant of FIG. 5B in which a previously recorded video clip is presented to the video communication session in place of the live video, to mitigate the visual distraction shown in the background of FIG. 5B, according to one or more embodiments;

FIG. 6B illustrates an example video communication session with the previously recorded video clip of the local participant being presented and several other external or remote participants, according to one or more embodiments;

FIGS. 7A-7B depict a flowchart of a method by which an electronic device monitors a background of a live video, and autonomously replaces the live video with a previously recorded video clip on detection of a visual distraction in the background, according to one or more embodiments; and

FIG. 8 depicts a flowchart of a method by which an electronic device synchronizes facial movements in a previously recorded video clip with audio input spoken by a local participant in a video communication session, according to one or more embodiments.

### DETAILED DESCRIPTION

According to one or more aspects of the present disclosure, the illustrative embodiments provide an electronic device, a method, and a computer program product for autonomously replacing a live video stream with a previously recorded video clip during a video communication session, in response to detecting a change in the background that is determined to potentially be a visual distraction.

An electronic device with a camera can be used to conduct a video communication session with one or more other electronic devices. Unfortunately, during a video communication session, a user may not notice other family members or individuals walking into the area and being included in the video being presented to the video communication session. The family member or individual entering the area may also be speaking or making audible sounds that can inadvertently interrupt the video communication session. The visual movements and audio sounds caused by the other family members or individuals entering into the field of view of the camera can be an unwanted interruption and distraction to the participants of the video communication session.

The embodiments disclosed herein addresses and overcome the aforementioned problems of an electronic device having a camera being used as a video capturing device for transmitting video of a local participant to a video communication session. One or more aspects of the embodiments disclosed herein enable an electronic device to detect a change in a background area adjacent to a background of a live video being presented to a video communication session. The embodiments enable the electronic device to, in response to detecting the change, stop presentation of the live video to the video communication session. The embodiments further enable the electronic device to retrieve a pre-recorded video clip of a local participant of the video communication session and present the pre-recorded video clip in place of the live video to the video communication session. Accordingly the disclosed embodiments enable the local participant to continue participating in the video communication session without the detected change in the background image causing a distraction to the other participants or an interruption to the video communication session.

In one embodiment, an electronic device includes a communications subsystem that enables the electronic device to communicatively connect to a video communication session involving at least one second electronic device. The electronic device includes a plurality of cameras, including a first camera that captures video and images from a first field of view (FOV) and a second camera that captures video and images from a second FOV that is wider and/or at a greater depth than the first FOV. The electronic device includes a memory that has stored thereon a communication module and a background monitoring and video replacement (BMVR) module for monitoring a background of a live video and autonomously replacing the live video with a previously recorded video clip during a video communication session when a potential distraction is detected in the live video background. The electronic device includes at least one processor that is communicatively coupled to the communications subsystem, each of the plurality of cameras, and the memory, and which executes program code of the communication module and the BMVR module. The at least one processor is configured to cause the electronic device to, while the electronic device is providing a live video to a first video communication session using the first camera, detect a change in a first background area adjacent/proximate to a visible background of the live video. The change includes at least one element that would present at least one visual distraction to other participants of the first video communication session. In response to detecting the change, the at least one processor pauses/stops presentation of the live video to the first video communication session. Concurrently, the at least one processor retrieves a first pre-recorded video clip of a local participant of the first video communication session who is being captured within the live video, and the at least one processor presents the first pre-recorded video clip in place of the live video to the first video communication session. Accordingly, a seamless transition is provided from the live video to the pre-recorded video clip.

According to another embodiment, the method includes, while an electronic device is providing a live video to a first video communication session using a first camera, detecting, via at least one processor, a change in a first background area adjacent to a visible background of the live video. The change comprising at least one element that would present at least one visual distraction to other participants of the first video communication session. In response to detecting the change, the method includes stopping presentation of the live video to the first video communication session. The method includes retrieving a first pre-recorded video clip of a local participant of the first video communication session who is being captured within the live video. The method includes presenting the first pre-recorded video clip in place of the live video to the first video communication session.

According to an additional embodiment, a computer program product includes a non-transitory computer readable storage device having stored thereon program code that, when executed by at least one processor of an electronic device having a communications subsystem, and a plurality of cameras including a first camera and a second camera, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

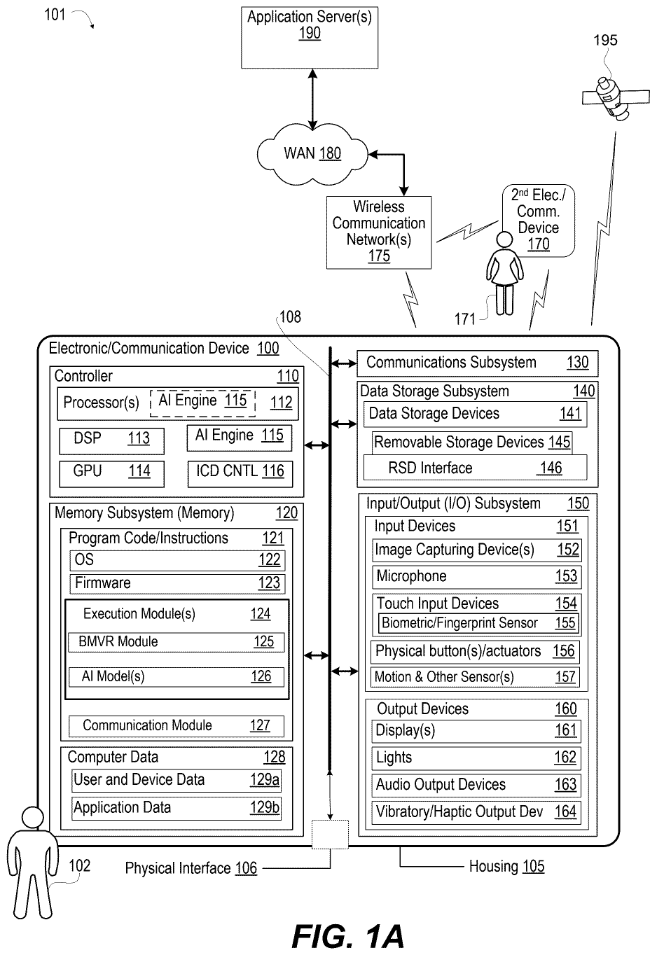

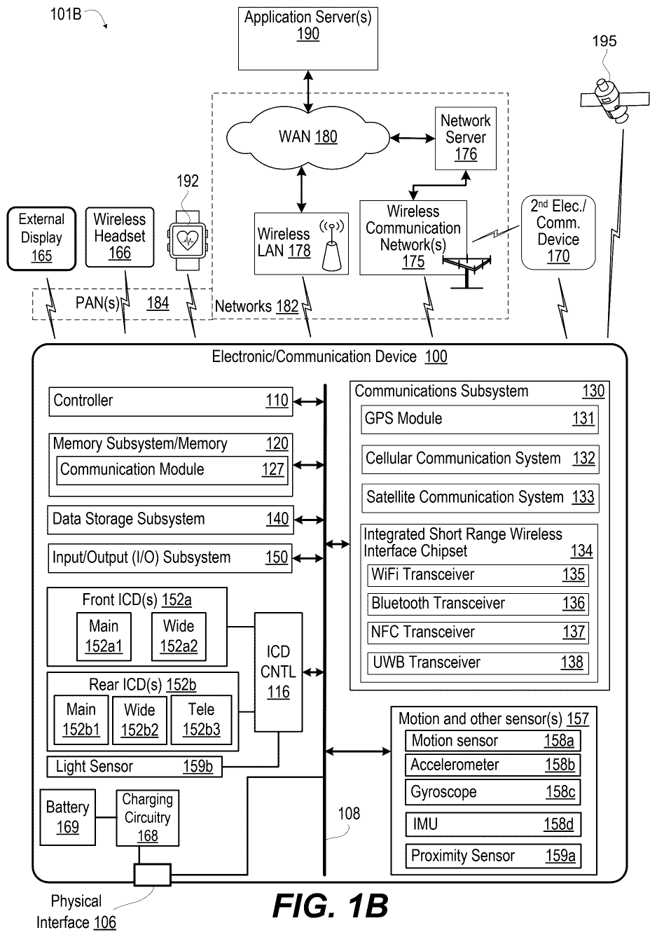

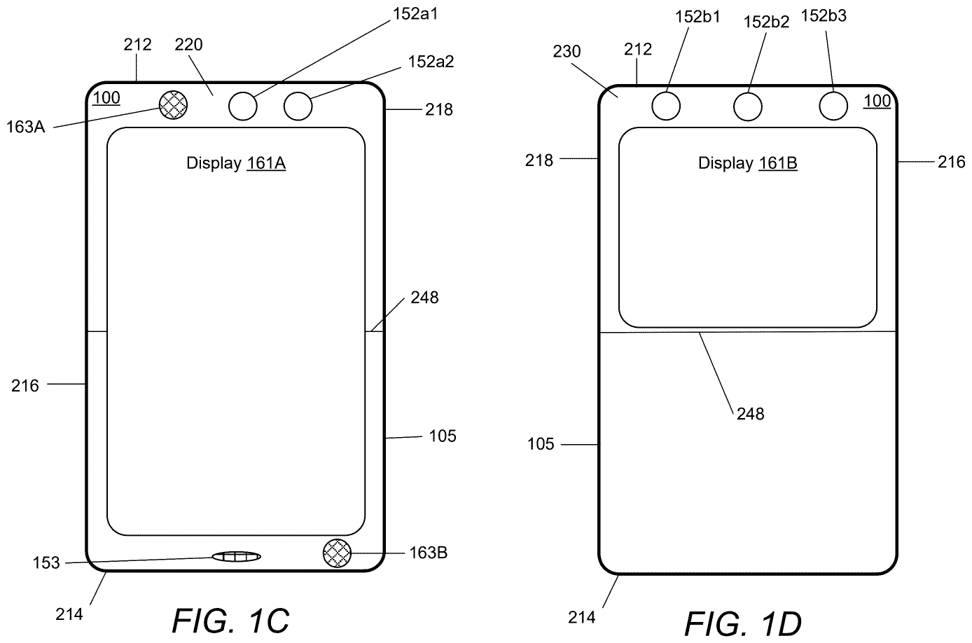

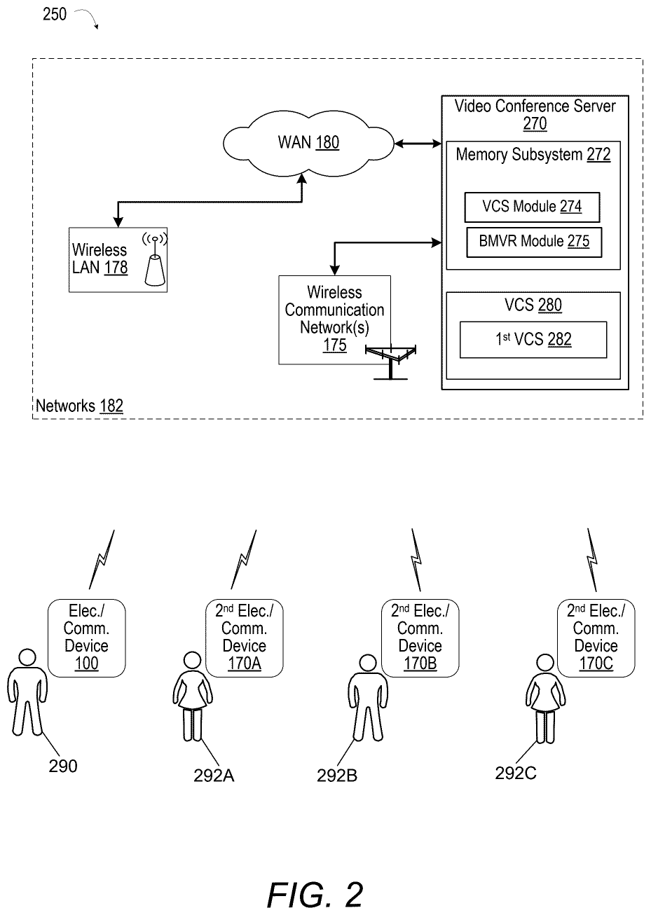

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices having at least one camera (or image capturing device).

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown).

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) include instructions for an operating system (OS) 122, firmware 123, such as basic input/output system (BIOS) or Uniform Extensible Firmware Interface (UEFI). Program code 121 includes execution module(s) 124 that collectively provides the various features of the disclosure.

Execution module(s) 124 include, without limitation, background monitoring and video replacement (BMVR) module 125. BMVR module 125 provides the features and operating functionality of the disclosed embodiments when the corresponding program instructions of BMVR module 125 are processed by/within processor 112/controller 110. Specifically, BMVR module 125 provides program instructions for monitoring a background of a live video being locally captured and presented to a video communication session, and after detecting a change in the background, replacing the live video with a previously recorded video clip during an ensuing period of the video communication session.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within BMVR module 125 and is trained to support the AI features of BMVR module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identify the underlying features performed by processing the different modules. For example, BMVR module 125 can include program instructions that cause or configure processor 112 to cause electronic device 100 to monitor a background of a live video and replace the live video with a previously recorded video clip during a video communication session. Other features provided by BMVR module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices. In one embodiment, communication module 127 enables electronic device 100 to establish and connect to a video communication session involving at least one second electronic device 170.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of BMVR module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, inertial measurement unit (IMU) 158d, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. IMU 158d measures force, angular rate, and orientation of electronic device 100, using a combination of accelerometers, gyroscopes, and magnetometers.

Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located or disposed on a rear surface of housing 105. Other embodiments provide for multiple integrated displays within electronic device 100 and references to display(s) 161 are assumed to refer to one or all of these multiple integrated displays.

Vibration/haptic output device 164 can cause electronic device 100 to vibrate or shake when activated. Vibration device 164 can be activated during an incoming call or message in order to provide an alert or notification to a user of electronic device 100. Audio output devices (e.g., a speaker) 163 can provide an audio alert or other audio output to a user. In one or more embodiments, integrated display 161, audio output devices (or speakers) 163, and vibration/haptic device 164 can generally and collectively be referred to as output devices.

With reference now to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone that is used by a second user 171, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of BMVR module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can also be used as a power supply port that is coupled to charging circuitry 168, which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 include front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152 a can include a main camera 152a1 and a wide-angle camera 152a2. Rear cameras 152b can include a main camera 152b1, a wide-angle camera 152b2, and a telephoto camera 152b3. Both sets of cameras 152 include image sensors that can capture images that are within the field of view (FOV) of each respective camera 152. In one or more embodiments, one or more of the cameras can be utilized to enable biometric authentication using facial image or iris scan recognition. In one embodiment, main camera 152a1 can be a high resolution camera that is used as a webcam during a video communication session.

In the description of each of the following figures, reference is also made to specific components illustrated within the preceding figure(s). Similar or same components are presented with the same leading reference number.

Turning to FIG. 1C, additional details of the front surface of electronic device 100 are shown. Electronic device 100 includes a housing 105 that contains the components of electronic device 100. Housing 105 includes a top side 212, bottom side 214, and opposed sides 216 and 218. Housing 105 further includes a front surface 220. Electronic device 100 includes a front display 161A embedded in front surface 220 of housing 105. In some implementations, microphone 153, front display 161A, front cameras 152a1, 152a2 and audio output devices 163A and 163B are at least partially integrated or disposed into front surface 220. In one embodiment, electronic device 100 can be a foldable electronic device that folds in half along a hinge 248.

Electronic device 100 includes a first audio output device 163A and second audio output device 163B. The first audio output device 163A is disposed or located towards top side 212 of housing 105. The second audio output device 163B is disposed or located towards bottom side 214 of housing 105. Each of the audio output devices 163A and 163B are communicatively coupled to processor 112.

With additional reference to FIG. 1D, additional details of the rear surface of housing 105 of electronic device 100 are shown. Electronic device 100 includes a rear display 161B embedded in rear surface 230 of housing 105. Various components of electronic device 100 are located or disposed on/at rear surface 230, including several rear cameras. In some implementations, rear display 161B, rear main camera 152b1, rear wide-angle camera 152b2, and rear telephoto camera 152b3 are at least partially integrated or disposed into rear surface 230. In one embodiment, electronic device 100 can fold in half along hinge 248. In the folded position, rear surface 230 becomes an outer surface of electronic device 100.

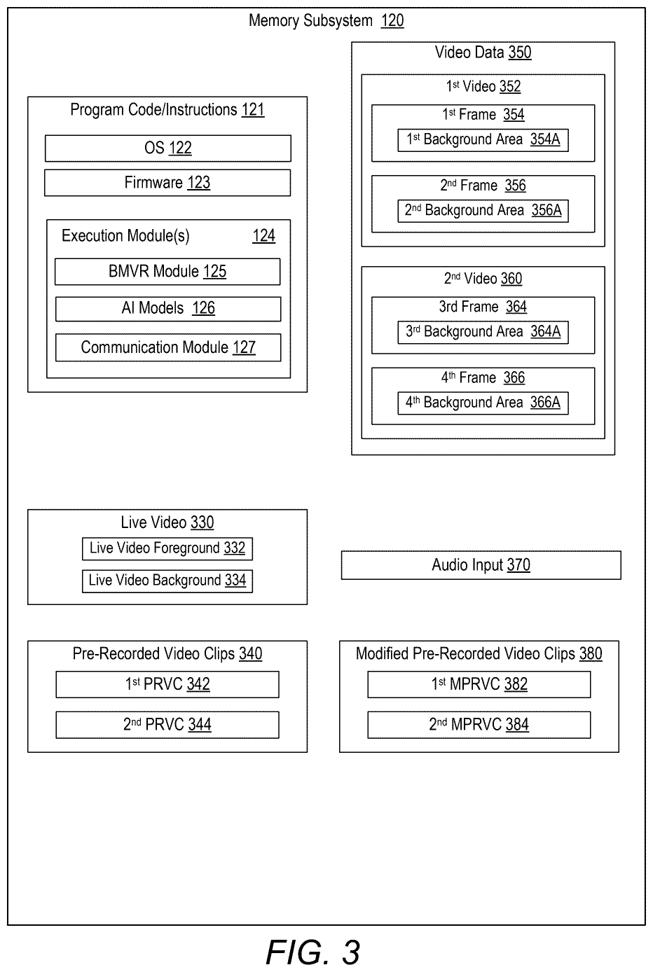

Referring to FIG. 2, a video communication session environment 250 is illustrated. Video communication session environment 250 enables one or more video communication sessions between electronic devices including electronic device 100, and several second electronic devices 170A, 170B, and 170C (170A-C). Video communication session environment 250 includes a video conference server 270 that is communicatively connected to CWCN 175 and WAN 180 of networks 182.

Video conference server 270 includes a memory subsystem 272. Memory subsystem 272 includes a video conference session module 274, and BMVR module 275. Video conference session module 274 enables video conference server 270 to establish and connect and facilitate video communication sessions (VCS) 280 involving electronic device 100 and second electronic devices 170A-C. Video communication sessions 280 use audio and video for two-way or multi-way communication(s) between electronic device 100 and second electronic devices 170A-C. Video communication sessions 280 include a first video communication session 282.

BMVR module 275 can provide a similar functionally for video conference server 270 as BMVR module 125 enables for electronic device 100. BMVR module 275 provides program instructions for configuring electronic device 100 to perform the functions of monitoring a background of a live video being presented/streamed to a video conference, and on detecting a change in the background, autonomously replacing the live video with a previously recorded video clip to avoid a distraction to the video communication session.

Video conference server 270 processes host-level functions for video communication sessions 280. Video communication sessions 280 are connected by video conference server 270 to each video communication session connected electronic device. Electronic device 100 captures a live video feed and transmits, via networks 182, the live video feed to video conference server 270. Video conference server 270 combines the videos received from multiple electronic devices and forwards the live video feeds to the second electronic devices. Electronic device 100 presents video received from video conference server 270 on a display (e.g., 161A or external display 165) for viewing by a local participant 290. Second electronic devices 170A-C present video received from video conference server 270 on a display for viewing by respective external or remote participants 292A, 292B, and 292C (292A-C).

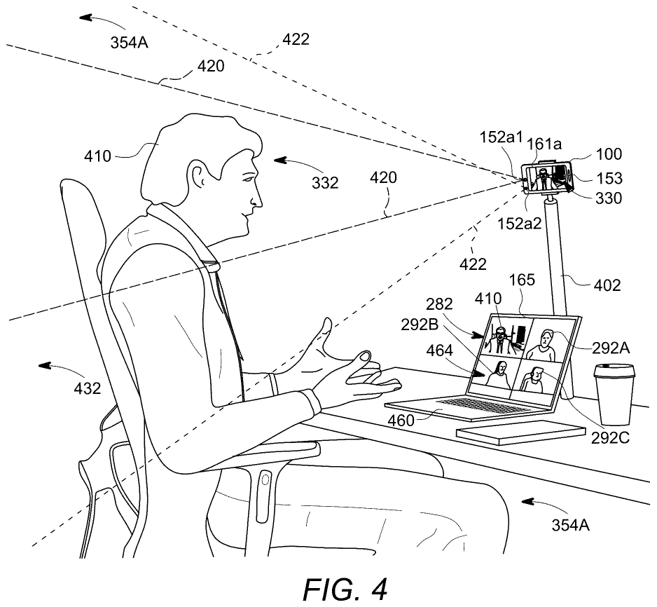

Referring to FIG. 3, there is shown one embodiment of example contents of memory subsystem 120 of electronic device 100. In the described embodiments, the contents of the memory are utilized to configure electronic device 100 to complete the various processes described herein. Memory subsystem 120 includes program code/instructions 121 including data, software, and/or firmware modules, such as operating system (OS) 122, firmware 123, and execution module(s) 124. Execution module(s) 124 include BMVR module 125, AI models 126, and communication module 127.

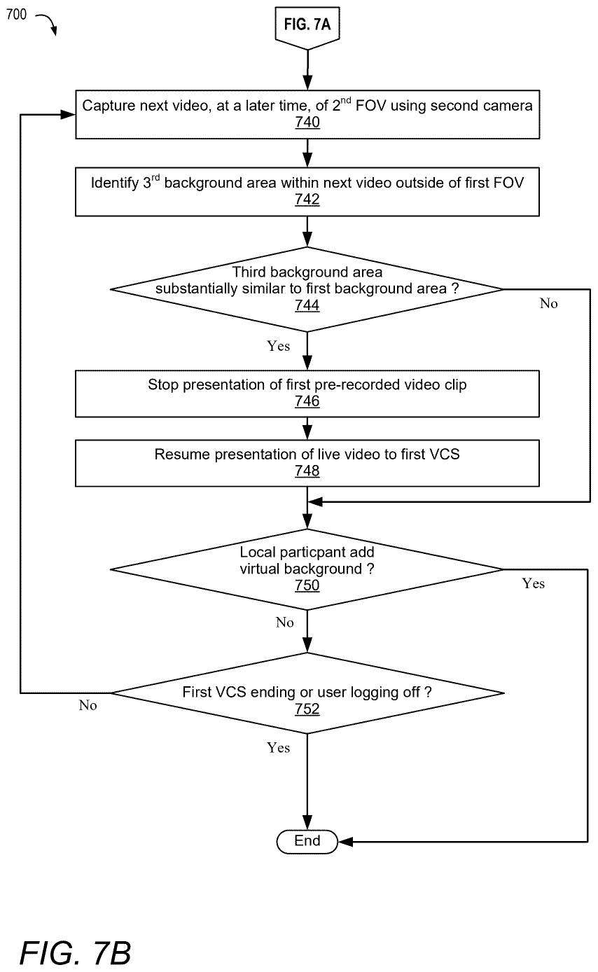

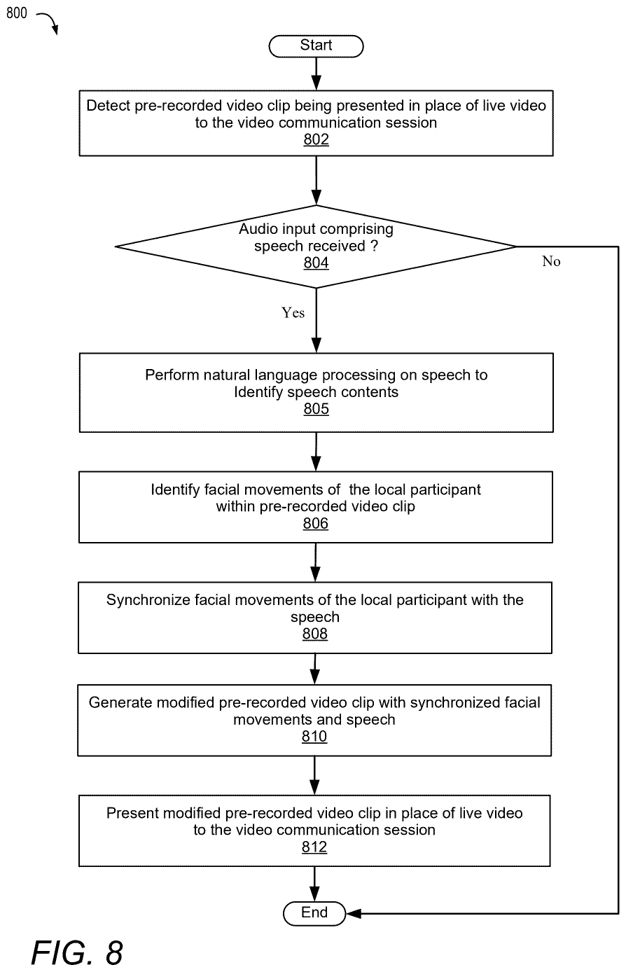

BMVR module 125 includes program code that is executed by processor 112 and configures processor 112 to enable/cause electronic device 100 to perform the various features of the present disclosure. In one or more embodiments, BMVR module 125 enables electronic device 100 to monitor a background of a live video being presented/streamed to a video conference, and on detecting a change in the background, autonomously replace the live video with a previously recorded video clip to avoid a distraction to the video communication session. In one or more embodiments, execution of BMVR module 125 by processor 112 configures electronic device 100 to perform the processes presented in the flowchart of FIGS. 7A-7B and 8, as will be described below.

AI models 126 accelerate artificial intelligence, natural language processing (NLP), context evaluation (CE), and machine learning applications. Communication module 127 enables electronic device 100 to communicate and exchange data with other devices via networks 182.

Memory subsystem 120 includes live video 330. Live video 330 can also be referred to as a live video feed. Live video 330 can be captured by front main camera 152a1 of electronic device 100 in real time and be presented to one or more video communication sessions 320. Live video 330 can include a foreground 332 and a background 334 that is captured within a field of view (FOV) by front main camera 152a1. Live video 330 may comprise a buffered segment of video that is captured by the front main camera, such as during a last 90 seconds. Earlier portions of live video 330 may be buffered on local storage and a most recent portion of live video 330 is forwarded to the video conference server 270 for sharing within the video communication session.

Memory subsystem 120 includes pre-recorded video clips 340. Pre-recorded video clips 340 are videos of a local participant of a current video communication session that are captured at an earlier time within live video 330 by one or more cameras 152 of electronic device 100. In one example embodiment, pre-recorded video clips 340 can be periodically captured and stored by electronic device 100 during a first video communication session 282. Pre-recorded video clips 340 include first pre-recorded video clip (PRVC) 342 and second pre-recorded video clip 344. Pre-recorded video clips 340 can have various lengths of recording live video. In one example embodiment, first pre-recorded video clip 342 can be one minute in length and second pre-recorded video clip 344 can be five minutes in length. Pre-recorded video clips 340 can be shorter in length than one minute or longer in length than five minutes. Pre-recorded video clips 340 can be earlier in time that the buffered portion of live video 330; although the buffered portion can also be stored as a pre-recorded video clip once the live video feed has been successfully transmitted/shared on the video communication session.

Memory subsystem 120 includes video data 350. Video data 350 is video captured by front ultra-wide camera 152a2 of electronic device 100. Video data 350 includes first video data 352 and second video data 360. First video data 352 includes a first frame 354 and second frame 356 that is captured at a later time. First frame 354 and second frame 356 are examples of many still images that compose a complete moving video. First frame 354 includes a first background area 354A and second frame 356 includes a second background area 356A. First background area 354A is an area in the background of the first frame 354 that is captured within a field of view of front ultra-wide camera 152a2. In one embodiment, front ultra-wide camera 152a2 captures, within a FOV that is wider than the FOV of front main camera 152a1, video and images that include the first background area 354A that is outside of or on a periphery of the live video background 334 captured by the front main camera 152a1. Second background area 356A is an area in the background of the second frame 356 that is captured at a later time. Second background area 356A is an area in the background of the second frame 356 that is captured within a field of view of front ultra-wide camera 152a2.

Second video data 360 includes third frame 364 and fourth frame 366. Second video data 360 is captured at a later time than first video data 352. Third frame 364 includes a third background area 364A and fourth frame 366 includes a fourth background area 366A. Fourth background area 366A is an area in the background of the fourth frame 366 that is captured at a later time.

Memory subsystem 120 includes audio input 370. Audio input 370 is audio received via an audio input device such as microphone 153. In one embodiment, audio input 370 can be speech spoken by a local participant of a video communication session.

Memory subsystem 120 includes modified pre-recorded video clips 380. Modified pre-recorded video clips 380 are generated by modifying the pre-recorded video clips 340 with synchronized facial movements of the local participant with the audio input 370 that comprises speech. Modified pre-recorded video clips 380 include first modified pre-recorded video clip (MPRVC) 382 and modified second pre-recorded video clip 384.

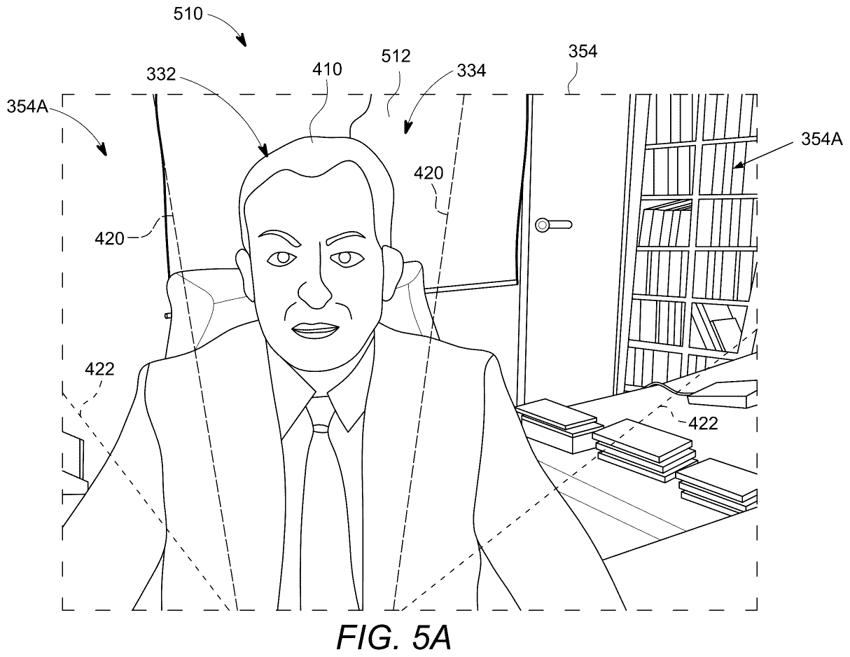

Referring to FIG. 4, electronic device 100 has been positioned to capture live video and audio of a local participant 410 during a first video communication session 282. Electronic device 100 is mounted to a stand 402 with display 161A and front cameras 152a1, 152a2 facing toward local participant 410. Front main camera 152a1 has a field of view (FOV) 420 that can capture images and video of the local participant 410 including a foreground 332 and background 334. Front ultra-wide camera 152a2 has a field of view (FOV) 422 that can capture images and video of areas that are outside of the FOV 420 captured by front main camera 152a1. Front ultra-wide camera 152a2 can capture images and video including a first background area 354A. Front ultra-wide camera 152a2 has FOV 422 that is wider than the FOV 420 of front main camera 152a1. In one embodiment, the first background area 354A captured by front ultra-wide camera 152a2 is outside of or on a periphery of the foreground 332 and background 334 captured by the front main camera 152a1. Microphone 153 can capture audio input 370 (i.e. speech) spoken by local participant 410 and can present the audio input 370 to the first video communication session 282.

In some embodiments, the first video communication session 282 can be presented to the local participant 410 via an external display 165 that is communicatively connected to electronic device 100. In one embodiment, external display 165 can be the display of laptop computer 460. The first video communication session 282, shown on external display 165, can include several other external or remote participants 292A-C that are shown in one or more windows (or panes) 464. At least one of windows 464 can include the presented video/image/icon of local participant 410.

In one embodiment, front main camera 152a1 can be a high resolution camera that is used as a webcam during the first video communication session 282. Front main camera 152a1 can have an improved video quality as compared to a camera of laptop computer 460. During the first video communication session 282, the live video 330 being presented to the first video communication session 282, can be shown on front display 161A. Live video 330 includes the local participant 410.

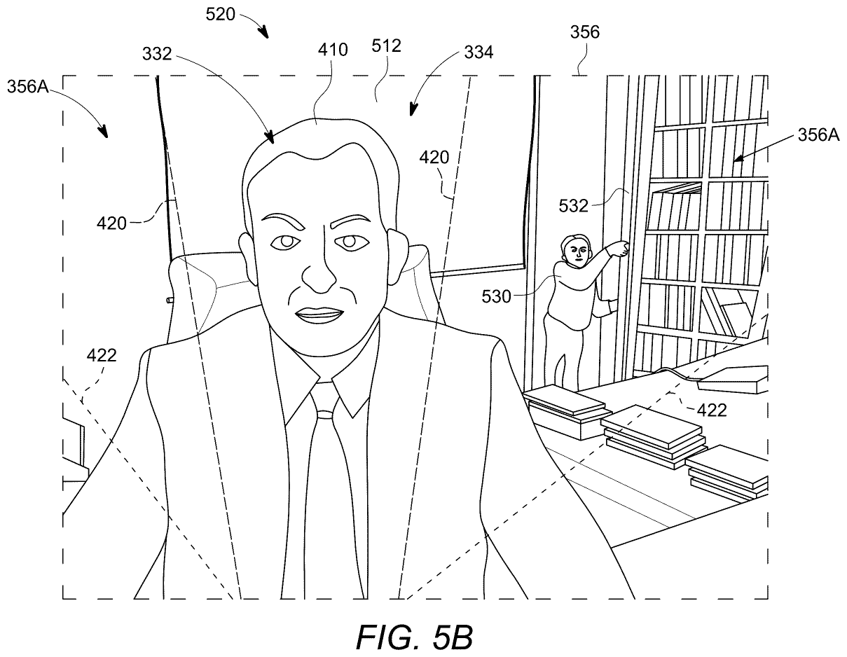

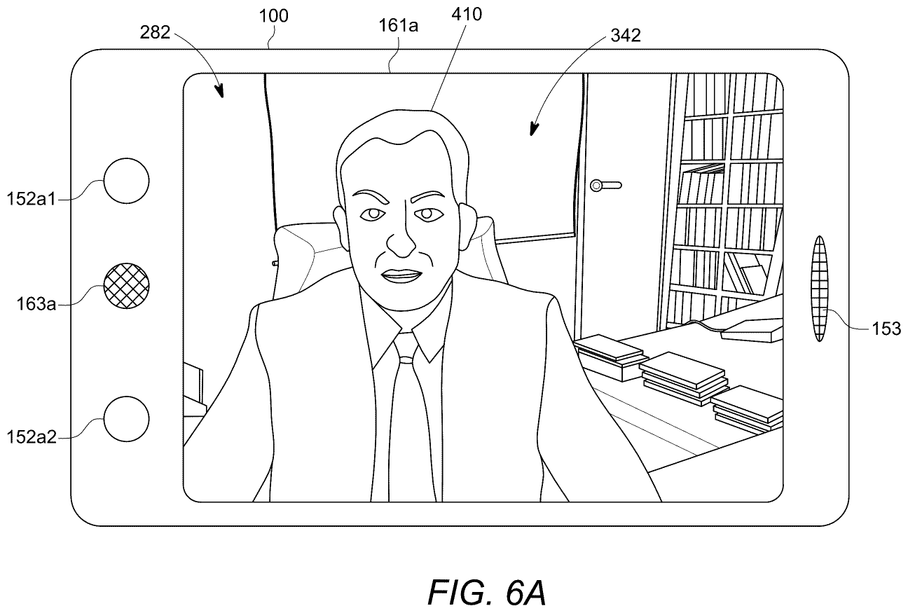

Turning to FIG. 5A, a first scene 510 is shown being presented by electronic device 100 to first video communication session 282. Scene 510 includes local participant 410 in a room 512 captured within live video 330 being presented to the first video communication session 282. Front main camera 152a1 captures, within FOV 420, live video 330 including foreground 332 and background 334. Front ultra-wide (UW) camera 152a2 captures, within UW FOV 422, first frame 354 that includes first background area 354A. First background area 354A is outside of or on a periphery of the background 334 of FOV 420. In one embodiment, during the video communication session, front ultra-wide camera 152a2 captures video data 350 comprising first video data 352 with a first frame 354 that includes the first background area 354A.

In one embodiment, during presentation of live video 330 to the first video communication session 282, electronic device 100 can record one or more pre-recorded video clips 340 of scene 510 that include video and audio (i.e., speech) of local participant 410. Pre-recorded video clips 340 of scene 520 are captured using front main camera 152a1.

With reference to FIG. 5B, scene 520 is illustrated with a child 530 opening door 532 and entering room 512 during the first video communication session 282. Scene 520 occurs at a later time after scene 510. The child 530 entering room 512 during the first video communication session 282 can be at least one element that would present at least one visual distraction to other participants of the first video communication session 282.

Front ultra-wide camera 152a2 captures, within FOV 422, second frame 356 that includes second background area 356A. Second background area 356A is outside of or on a periphery (lateral or depth) of the background 334. In one embodiment, during the video communication session, front ultra-wide camera 152a2 captures video data 350 comprising first video data 352 with a second frame 356 that includes the second background area 356A.

Scene 520 of FIG. 5B is different than scene 510 of FIG. 5A in that child 530 has opened door 532 and entered into room 512 during the first video communication session 282. The child 530 entering room 512 during the first video communication session 282 can be an unwanted visual and audible distraction to other participants of the first video communication session 282. The child 530 entering room 512 causes a change to the second background area 356A from the first background area 354A, such that the second background area 356A is different from the first background area 354A.

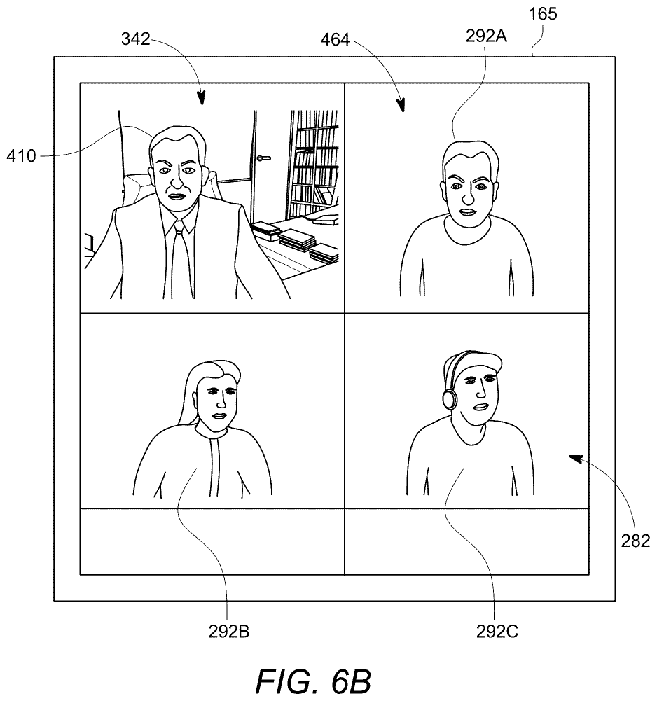

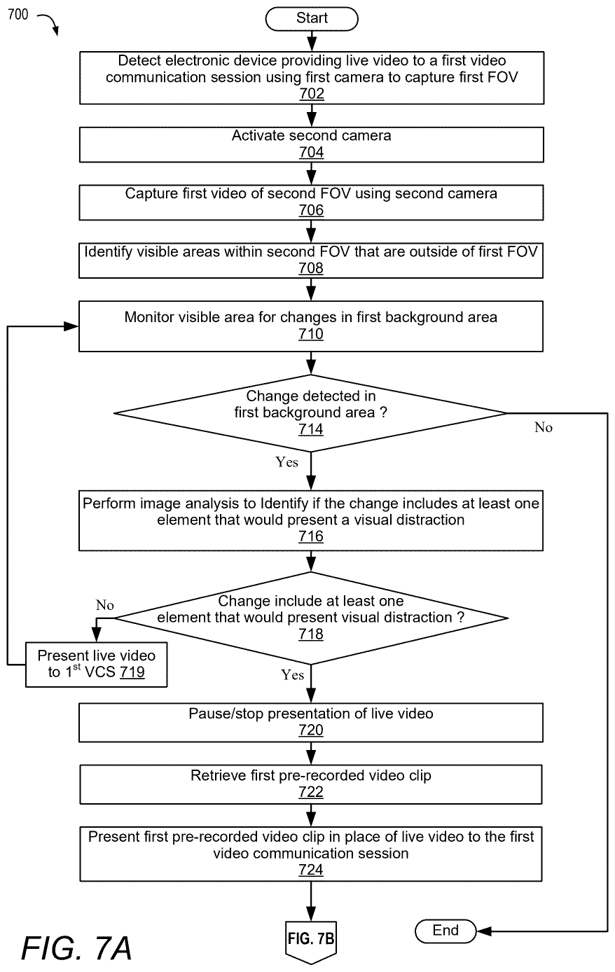

With reference to FIG. 6A, electronic device 100 is shown presenting the first pre-recorded video clip 342 on front display 161A in place of the live video 330 to the first video communication session 282. After detecting a change in the peripheral background of the local participant 410 of the video communication session that is determined to be an unwanted visual (and audible) distraction to other remote participants 292A-292C of the first video communication session, electronic device 100 replaces the live video 330 with the first pre-recorded video clip 342, in a seamless manner to avoid distractions to the other remote participants 292A-292C. The first pre-recorded video clip 342, which does not include the element that is causing a visual distraction in the live video, is then presented to the first video communication session 282.

With reference to FIG. 6B, external display 165 of laptop 460 is shown presenting the first pre-recorded video clip 342 of the local participant in place of live video 330 in window 464 assigned to display local participant video to the first video communication session 282. The first video communication session 282 includes the local participant 410 and the other remote participants 292A-292C. After detecting a change in the peripheral background of the local participant 410 of the video communication session that is determined to be an unwanted visual distraction to other remote participants 292A-292C of the first video communication session, electronic device 100 replaces the live video 330 with the first pre-recorded video clip 342, in a seamless manner to avoid visual distractions to the other remote participants 292A-292C. The first pre-recorded video clip 342, which does not include the element that is causing a visual distraction in the live video, is presented to the first video communication session 282 in place of the live video. In a further embodiment, when a change is detected that is determined to be an unwanted visual distraction to other remote participants 292A-292C of the first video communication session, microphone 153 can be muted, when the local participant is not speaking, so that audible distractions are not presented to the first video communication session.

Playing the first pre-recorded video clip 342, in place of the live video 330, prevents the external or remote participants 292A-C of the first video communication session from viewing and/or hearing an interruption or distraction to the video communication session. In one embodiment, electronic device 100 can determine the element that is causing a visual distraction (i.e., child 530) is no longer present in the background area and revert to presenting the live video 330. Electronic device 100 stops presentation of the first pre-recorded video clip 342 to the first video communication session 282 and resumes presentation of the live video 330 to the first video communication session 282, in a substantially seamless manner.

According to one aspect of the disclosure, while electronic device 100 is providing a live video 330 to a first video communication session 282 using a first camera (e.g. front main camera 152a1) electronic device 100 detects, a change in a first background area 354A adjacent/proximate to a background 334 of the live video. The detected change can be adjacent/proximate to, but not presented within, the visible background captured in the FOV 420 of front main camera 152a1. The change can include at least one element (e.g., child 530 entering) that would present at least one visual distraction to other participants of the first video communication session 282. Additional processing can be triggered/initiated, including use of AI engine 115/AI models 126, to evaluate the element found in the image against a known knowledgebase of images that can/cannot be a distraction warranting the replacement of the live video. For example, entry of a house pet into the peripheral view of the background area may not be deemed a big enough distraction to trigger the replacement. As another example, entry of a spouse or co-worker who is known to the other parties on the video communication session and who may be joining the video session from the same room via the electronic device would not be a change that would be deemed a distraction. In response to detecting the change and determining the change can potentially be a distraction, electronic device 100 retrieves a first pre-recorded video clip 342 of a local participant 410 of the first video communication session, and electronic device 100 presents the first pre-recorded video clip 342 in place of the live video 330 to the first video communication session 282. In one or more embodiments, electronic device 100 stops presentation of the live video 330 to the first video communication session 282 concurrently with presenting the first pre-recorded video clip 342 to provide for a near seamless transition in the live video feed being transmitted to the video communication session. In one embodiment, the first pre-recorded video clip 342 is a buffered loop of the last 30 to 60 seconds of the live video 330 from before the distraction occurs.

According to another aspect of the disclosure, to detect the change, electronic device 100 periodically (or in an always-on mode) activates the second camera (e.g. front ultra-wide camera 152a2) to capture a second FOV 422 comprising the first background area 354A during the video communication session. Electronic device 100 identifies visible areas within the second FOV 422 that are outside of or on a periphery of a first FOV 420. Electronic device 100 monitors the visible areas for changes that can correspond to the at least one visual distraction. In response to detecting the change, electronic device 100 performs an image analysis to identify whether the change comprises the at least one element (e.g., child 530 entering) that would present the at least one visual distraction. Electronic device 100 triggers stopping of the live video 330, in response to the change comprising the at least one element. In one embodiment, where no previous video clips are available for selection and presentation, electronic device 100 may instead stop transmitting a video feed for the local participant and replace the video feed with a still image or icon or other acceptable image.

According to an additional aspect of the disclosure, to detect the change, electronic device 100 extracts a first frame 354 from a first video 352 captured by the second camera (e.g., front ultra-wide camera 152a2) at a first time. Electronic device 100 identifies the first background area 354A within the first frame 354. Electronic device 100 extracts a second frame 356 from the first video 352 at a second, later time. Electronic device 100 identifies a second background area 356A within the second frame 356. Electronic device 100 determines if visual features of the second background area 356A are sufficiently different from visual features of the first background area 354A. In response to determining visual features of the second background area 356A are sufficiently different from the first background area 354A, electronic device 100 triggers replacing the presentation of the live video 330 with the pre-recorded video clip.

In one embodiment, image processing techniques such as image subtraction or difference imaging can be used to compare pixels between the second background area 356A and the first background area 354A. The digital numeric value of pixels in an image is subtracted from another image, and a new image is generated from the result. This method allows the detection of changes between two images. This method can show things in the image that have changed in position or shape. When a certain number of pixels have been detected as being changed or different, then the visual features of the second background area 356A are sufficiently different from the first background area 354A to trigger replacing the presentation of the live video with the pre-recorded video clip. Different methods for determining differences between two images can be utilized in other embodiments.

According to one more aspect of the disclosure, electronic device 100 captures a second video/image 360 of the second FOV 422, via the second camera (e.g., front ultra-wide camera 152a2) at a third later time. Electronic device 100 extracts a third frame 364 from the second video/image 360 and identifies a third background area 364A (e.g., image of the same/similar space as the second background area, captured at a later time) within the third frame 364. Electronic device 100 determines if visual features of the third background area 364A are substantially similar to the first background area 354A indicating that the at least one element that would present the at least one visual distraction is no longer present. In response to determining visual features of the third background area 364A are substantially similar to the first background area 354A, electronic device 100 transitions from presenting the first pre-recorded video clip 342 to the first video communication session 282 and resumes presentation of the live video 330 to the first video communication session 282.

According to yet another aspect of the disclosure, electronic device 100 determines if first audio input 370 comprising speech is being received via an audio input device 153. In response to determining the first audio input 370 comprising speech is being received, electronic device 100 confirms a source of the speech as the local participant by monitoring for specific facial movements of the local participant 410 within a foreground of the live video that is being captured but not being presented. Electronic device 100 performs natural language processing (NLP) on the detected speech and analyzes the speech to determine if the content of the speech is directed to the video communication session and not the local distraction (e.g., the local microphone has been unmuted while the pre-recorded video clip 382 is being presented). In response to confirming the local participant 410 is speaking, electronic device 100 generates a modified first pre-recorded video clip 382 by synchronizing facial movements of the local participant image within the pre-recorded video clip with the received first audio input 370. Electronic device 100 presents the modified first pre-recorded video clip 382 in place of the live video 330 and the original pre-recorded video clip 342 to the first video communication session 282 while the visual distraction is still present and the local participant is determined to be speaking to the video communication session.

According to one more aspect of the disclosure, electronic device 100 determines if first audio input 370 comprising speech is being received via an audio input device 153. In response to determining the first audio input 370 comprising speech is being received, electronic device 100 confirms a source of the speech as the local participant by monitoring for specific facial movements of the local participant 410 within a foreground of the live video that is being captured but not being presented. In response to confirming the local participant 410 is speaking, electronic device 100 selects a pre-recorded video clip that includes the local participant speaking. Electronic device 100 presents the pre-recorded video clip that includes the local participant speaking in place of the live video 330, while the visual distraction is still present.

According to a further aspect of the disclosure, in response to not detecting audible speech (or determining the first audio input 370 does not comprise speech, electronic device 100 selects a second pre-recorded video clip 344 from among a plurality of pre-recorded video clips that does not present the local participant 410 speaking. Electronic device 100 presents the second pre-recorded video clip 344 in place of the live video 330 to the first video communication session 282.

According to one or more additional aspect(s) of the disclosure, the first camera (e.g., front main camera 152a1) is a normal angle FOV camera that captures, within the first FOV 420, video and images of the local participant 410 of the first video communication session and the second camera (e.g., front ultra-wide camera 152a2) is an ultra-wide angle FOV camera that captures, within the second FOV 422 that is wider than the first FOV, video and images comprising the first background area 354A that is outside of or on a periphery of the first FOV 420 of the first camera.

FIGS. 7A-7B depict a flow chart presenting method 700 by which electronic device 100 monitors a background of a live video and autonomously replaces the live video with a previously recorded video clip on detection of a visual distraction in the background. FIG. 8 depicts a flow chart presenting method 800 by which electronic device 100 synchronizes facial movements in a previously recorded video clip with audio input spoken by a local participant in a video communication session. The description of methods 700 and 800 will be described with reference to the components and examples of FIGS. 1-6B. The operations depicted in FIGS. 7A-7B and 8 can be performed by electronic device 100 or any suitable electronic device that includes the one or more functional components of electronic device 100 that provide/enable the described features. One or more of the processes of the methods described in FIGS. 7A-7B and 8 may be performed by processor 112 executing program code associated with BMVR module 125.

With specific reference to FIG. 7A, method 700 begins at the start block. At block 702, method 700 includes detecting that electronic device 100 is providing a live video 330 to a first video communication session 282 using front main camera 152a1 capturing first FOV 420. Method 700 includes activating front ultra-wide camera 152a2 (block 704) and capturing a first video 352 of the second FOV 422 including first background area 354A using the front ultra-wide camera 152a2 (block 706). Method 700 includes identifying visible areas within the second FOV 422 that are outside of or on a periphery of the first FOV 420 (block 708) and monitoring the visible areas for changes that can correspond to at least one visual distraction entering or approaching the first FOV of the front main camera 152a1 (block 710).

Method 700 includes determining if a change has been detected in a first background area 354A adjacent to a background 334 of the live video (decision block 714). The detected change can be adjacent/proximate to, but not presented within, the visible background captured in the FOV 420 of front main camera 152a1. In one embodiment, the change includes at least one element (e.g., child 530 entering) that would present at least one visual distraction to other participants of the first video communication session 282. In response to determining that a change has not been detected in first background area 354A, method 700 includes continuing to present live video 330 to the first video communication session 282 (block 730). Method 700 ends at the end block.

In response to determining that a change has been detected in first background area 354A, method 700 includes performing an image analysis to identify characteristics of the change being one(s) that would present the at least one visual distraction (block 716). In one embodiment, method 700 can use AI techniques to identify if the characteristics of the change in the first background are sufficient to present at least one visual distraction. As an example, the AI engine 115/AI models 126 can access/reference a pre-determine compiled list of possible distractions, which can be compiled by the AI engine/models and updated over a period of time and/or retrieved from an online resource that receives data tracking types of distractions detected across multiple different video conferences in different scenarios. Method 700 includes determining if the change comprises the at least one element that would present at least one visual distraction to other participants of the first video communication session 282 (decision block 718). In response to determining that the change does not comprise the at least one element that would present at least one visual distraction to other participants of the first video communication session, method 700 includes continuing to present live video 330 to the first video communication session 282 (block 719). Method 700 returns to block 710 to continue monitoring the visible areas for changes that can correspond to at least one visual distraction entering or approaching the first FOV of the front main camera 152a1.

In response to determining that the change does comprise at least one element that would present at least one visual distraction to other participants of the first video communication session, method 700 includes pausing presentation of the live video 330 to the first video communication session 282 (block 720). Method 700 includes retrieving a first pre-recorded video clip 342 of a local participant 410 of the first video communication session (block 722). Method 700 includes presenting the first pre-recorded video clip 342 in place of the live video 330 to the first video communication session 282 (block 724). In one embodiment, the first pre-recorded video clip 342 is a buffered loop of the last 30 to 60 seconds of the live video 330 from before the at least one visual distraction occurs. It is appreciated that a different length video clip can be provided, in alternate embodiments.

Turning to FIG. 7B, at block 740, method 700 includes capturing a next video (e.g. second video 360) of the second FOV 422 including third background area 364A at a later time. Method 700 includes identifying third background area 364A in second video 360 within the second FOV 422 that are outside of or on a periphery of the first FOV 420 (block 742). Method 700 includes determining if the third background area 364A is substantially similar to the first background area 354A (decision block 744). When the at least one visual distraction is no longer present in the background area, the third background area 364A will be substantially similar to the first background area 354A. In response to determining that the third background area 364A is substantially similar to the first background area 354A, method 700 includes stopping presentation of the first pre-recorded video clip 342 (block 746) and resuming presentation of the live video 330 to the first video communication session 282 (block 748).

After block 748 or in response to determining that the third background area 364A is not substantially similar to the first background area 354A, method 700 includes determining if the local participant 410 has selected a virtual background to replace the first background area 354A with the at least one visual distraction (decision block 750). In response to determining the local participant 410 has selected a virtual background to replace the first background area 354A, method 700 terminates at the end block. In response to determining the local participant 410 has not selected a virtual background to replace the first background area 354A, method 700 includes determining if the first video communication session 282 is ending or the user is logging off (decision block 752). In response to determining the first video communication session 282 has not ended, method 700 returns to block 740 to continue capturing another video of the second FOV 422 at a later time. In response to determining the first video communication session 282 has ended, method 700 ends at the end block.

FIG. 8 depicts a flow chart presenting method 800 by which electronic device 100 synchronizes facial movements in a previously recorded video clip with audio input spoken by a local participant in a video communication session. With specific reference to FIG. 8, method 800 begins at the start block. At block 802, method 800 includes detecting the first pre-recorded video clip 342 being presented in place of the live video 330 to the first video communication session 282. In response to detecting the first pre-recorded video clip 342 being presented in place of the live video 330 to the first video communication session 282, method 800 includes determining if first audio input 370 comprising speech is being received via audio input device 153 (decision block 804). In response to determining that no audio input 370 comprising speech is being received, method 800 terminates at the end block.

In response to determining that the first audio input 370 comprising speech is being received, method 800 includes performing natural language processing (NLP) on the detected speech and analyzing the speech to determine words being spoken that represents speech intended to be communicated to the video communication session (block 805). Method 800 includes identifying facial movements of the local participant 410 within a foreground of the live video feed that is not being presented to the video communication session (block 806). In one embodiment, method 800 utilizes AI features of BMVR module 125 such as AI image analysis to identify the facial movements of the local participant 410. Method 800 includes synchronizing facial movements of the local participant within the first pre-recorded video clip 382 with the first audio input 370 comprising speech (block 808). Method 800 includes generating a modified first pre-recorded video clip 382 with the synchronized facial movements of the local participant and speech (block 810).

In one embodiment, method 800 utilizes AI features of BMVR module 125 to identify facial movements of the local participant 410 and synchronize the facial movements of the local participant within first pre-recorded video clip 382 with the spoken words (i.e., first audio input 370). Method 800 includes presenting the modified first pre-recorded video clip 382 in place of the live video 330 to the first video communication session 282 (block 812). Method 800 ends at the end block.

The disclosure provides improvements in an electronic device being used in a video communication session by enabling the electronic device to prevent events occurring in the periphery of the background of a local participant from being included in the video feed being presented to a video communication session, thus preventing the event from becoming a distraction to the video communication session. By replacing the live video with a pre-recorded video clip of the local participant, distractions are prevented and the video communication session is not interrupted. Additionally, by presenting an AI representation of the movement of a participants lips during detected speech by the local participants, the disclosure allows the pre-recorded video clip to present as a live video of the participant speaking, further reducing the distraction that would be caused by the recorded video presenting images of a non-speaking local participant while participant speech is being presented to the video communication session.

The disclosure enables an ultra-wide camera to function as a detector to detect changes in a background area, such as the entry of a person into a room. When a change to a background area is detected, the electronic device interrupts the live video to show pre-recorded video clips. Another benefit includes, if the local participant starts talking during presentation of the pre-recorded video clip, the electronic device will adjust the lip synchronization of the pre-recorded video clip being shown to match the spoken speech. Further, the disclosure enables an electronic device to stop presenting the pre-recorded video clip and switch back to presenting live video, in response to no longer detecting a visual distraction in the background.

In the above-described methods of FIGS. 7A-7B and 8, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem that enables the electronic device to communicatively connect to a video communication session involving at least one second electronic device;
a plurality of cameras, including a first camera that captures video and images from a first field of view (FOV) and a second camera that captures video and images from a second FOV that is wider than the first FOV;
a memory having stored thereon a communication module and a background monitoring/video replacement (BMVR) module for monitoring a background of a live video and replacing the live video with a previously recorded video clip during a video communication session; and
at least one processor communicatively coupled to the communications subsystem, each of the plurality of cameras, and the memory, and which executes program code of the communication module and the BMVR module, the at least one processor configured to cause the electronic device to:
while the electronic device is providing a live video to a first video communication session using the first camera, detect a change in a first background area adjacent to a background of the live video, the change comprising at least one element that would present at least one visual distraction to other participants of the first video communication session; and
in response to detecting the change:
stop presentation of the live video to the first video communication session;
retrieve a first pre-recorded video clip of a local participant of the first video communication session, the local participant captured within the live video; and
present the first pre-recorded video clip in place of the live video to the first video communication session.

2. The electronic device of claim 1, wherein to detect the change, the at least one processor is configured to cause the electronic device to:
activate the second camera to capture the second FOV comprising the first background area during the video communication session;
identify visible areas within the second FOV that are outside of or on a periphery of the first FOV;
monitor the visible areas for changes that can correspond to the at least one visual distraction;
in response to detecting the change, perform image analysis to identify whether the change comprises the at least one element that would present the at least one visual distraction;
and trigger stopping of the live video, in response to the change comprising the at least one element.

3. The electronic device of claim 1, wherein to detect the change, the at least one processor configures the electronic device to:
extract a first frame from a first video captured by the second camera at a first time;
identify the first background area within the first frame;
extract a second frame from the first video at a second, later time;
identify a second background area within the second frame;
determine if visual features of the second background area are sufficiently different than visual features of the first background area; and
in response to determining visual features of the second background area are sufficiently different from the first background area, trigger stopping of the presentation of the live video.

4. The electronic device of claim 3, wherein the at least one processor is configured to cause the electronic device to:
capture a second video of the second FOV, via the second camera, at a third later time;
extract a third frame from the second video;
identify a third background area within the third frame;
determine if visual features of the third background area are substantially similar to the first background area indicating that the at least one element that would present the at least one visual distraction is no longer present;
in response to determining visual features of the third background area are substantially similar to the first background area, stop presentation of the first pre-recorded video clip to the first video communication session; and
resume presentation of the live video to the first video communication session.

5. The electronic device of claim 1, further comprising:
an audio input device, the audio input device communicatively coupled to the at least one processor;
wherein the at least one processor is configured to cause the electronic device to:
determine if a first audio input comprising speech has been received via the audio input device; and
in response to determining the first audio input comprising speech has been received:
identify facial movements of the local participant within a foreground of the first pre-recorded video clip;
generate a modified first pre-recorded video clip by synchronizing facial movements of the local participant with the first audio input comprising speech; and
present the modified first pre-recorded video clip in place of the live video to the first video communication session.

6. The electronic device of claim 5, wherein the at least one processor is configured to cause the electronic device to:
in response to determining the first audio input comprising speech has not been received, select a second pre-recorded video clip from among a plurality of pre-recorded video clips that does not present the local participant speaking; and
present the second pre-recorded video clip in place of the live video to the first video communication session.

7. The electronic device of claim 1, wherein the first camera is a normal angle FOV camera that captures, within the first FOV, video and images of the local participant of the first video communication session and the second camera is an ultra-wide angle FOV camera that captures, within the second FOV that is wider than the first FOV, video and images comprising the first background area that is outside of or on a periphery of the first FOV of the first camera.

8. A method comprising:
while an electronic device is providing a live video to a first video communication session using a first camera, detecting, via at least one processor, a change in a first background area adjacent to a background of the live video, the change comprising at least one element that would present at least one visual distraction to other participants of the first video communication session; and
in response to detecting the change:
stopping presentation of the live video to the first video communication session;
retrieving a first pre-recorded video clip of a local participant of the first video communication session, the local participant captured within the live video; and
presenting the first pre-recorded video clip in place of the live video to the first video communication session.

9. The method of claim 8, wherein to detect the change, the method further comprises:
activating a second camera to capture a second field of view (FOV) comprising the first background area during the video communication session;
identifying visible areas within the second FOV that are outside of or on a periphery of a first FOV;
monitoring the visible areas for changes that can correspond to the at least one visual distraction;
in response to detecting the change, performing image analysis to identify whether the change comprises the at least one element that would present the at least one visual distraction; and
triggering stopping of the live video, in response to the change comprising the at least one element.

10. The method of claim 8, wherein to detect the change, the method further comprises:
extracting a first frame from a first video captured by a second camera at a first time;
identifying the first background area within the first frame;
extracting a second frame from the first video at a second, later time;
identifying a second background area within the second frame;
determining if visual features of the second background area are sufficiently different than visual features of the first background area; and
in response to determining visual features of the second background area are sufficiently different from the first background area, triggering stopping of the presentation of the live video.

11. The method of claim 10, further comprising:
capturing a second video of a second FOV, via the second camera, at a third later time;
extracting a third frame from the second video;
identifying a third background area within the third frame;
determining if visual features of the third background area are substantially similar to the first background area indicating that the at least one element that would present the at least one visual distraction is no longer present;
in response to determining visual features of the third background area are substantially similar to the first background area, stopping presentation of the first pre-recorded video clip to the first video communication session; and
resuming presentation of the live video to the first video communication session.

12. The method of claim 8, further comprising:
determining if a first audio input comprising speech has been received via an audio input device; and
in response to determining the first audio input comprising speech has been received:
identifying facial movements of the local participant within a foreground of the first pre-recorded video clip;
generating a modified first pre-recorded video clip by synchronizing facial movements of the local participant with the first audio input comprising speech; and
presenting the modified first pre-recorded video clip in place of the live video to the first video communication session.

13. The method of claim 12, further comprising:
in response to determining the first audio input comprising speech has not been received, selecting a second pre-recorded video clip from among a plurality of pre-recorded video clips that does not present the local participant speaking; and
presenting the second pre-recorded video clip in place of the live video to the first video communication session.

14. The method of claim 8, wherein the first camera is a normal angle field of view (FOV) camera that captures, within a first FOV, video and images of the local participant of the first video communication session and a second camera is an ultra-wide angle FOV camera that captures, within a second FOV that is wider than the first FOV, video and images comprising the first background area that is outside of or on a periphery of the first FOV of the first camera.

15. A computer program product comprising:
a computer readable storage device having stored thereon program code which, when executed by at least one processor of an electronic device having a communications subsystem that enables the electronic device to communicatively connect to a video communication session involving at least one second electronic device and a plurality of cameras, including a first camera that captures video and images from a first field of view (FOV) and a second camera that captures video and images from a second FOV that is wider than the first FOV, configures the electronic device to complete the functionality of:
while the electronic device is providing a live video to a first video communication session using the first camera, detecting a change in a first background area adjacent to a background of the live video, the change comprising at least one element that would present at least one visual distraction to other participants of the first video communication session; and
in response to detecting the change:
stopping presentation of the live video to the first video communication session;
retrieving a first pre-recorded video clip of a local participant of the first video communication session, the local participant captured within the live video; and
presenting the first pre-recorded video clip in place of the live video to the first video communication session.

16. The computer program product of claim 15, wherein to detect the change, the program code further configures the electronic device to complete the functionality of:
activating the second camera to capture the second FOV comprising the first background area during the video communication session;
identifying visible areas within the second FOV that are outside of or on a periphery of a first FOV;
monitoring the visible areas for changes that can correspond to the at least one visual distraction;
in response to detecting the change, performing image analysis to identify whether the change comprises the at least one element that would present the at least one visual distraction; and
triggering stopping of the live video, in response to the change comprising the at least one element.

17. The computer program product of claim 15, wherein to detect the change, the program code further configures the electronic device to complete the functionality of:
extracting a first frame from a first video captured by the second camera at a first time;
identifying the first background area within the first frame;
extracting a second frame from the first video at a second, later time;
identifying a second background area within the second frame;
determining if visual features of the second background area are sufficiently different than visual features of the first background area; and
in response to determining visual features of the second background area are sufficiently different from the first background area, triggering stopping of the presentation of the live video.

18. The computer program product of claim 17, wherein the program code further configures the electronic device to complete the functionality of:
capturing a second video of the second FOV, via the second camera, at a third later time;
extracting a third frame from the second video;
identifying a third background area within the third frame;
determining if visual features of the third background area are substantially similar to the first background area indicating that the at least one element that would present the at least one visual distraction is no longer present;
in response to determining visual features of the third background area are substantially similar to the first background area, stopping presentation of the first pre-recorded video clip to the first video communication session; and
resuming presentation of the live video to the first video communication session.

19. The computer program product of claim 15, wherein the program code further configures the electronic device to complete the functionality of:
determining if a first audio input comprising speech has been received via an audio input device; and
in response to determining the first audio input comprising speech has been received:
identifying facial movements of the local participant within a foreground of the first pre-recorded video clip;
generating a modified first pre-recorded video clip by synchronizing facial movements of the local participant with the first audio input comprising speech; and
presenting the modified first pre-recorded video clip in place of the live video to the first video communication session.

20. The computer program product of claim 19, wherein the program code further configures the electronic device to complete the functionality of:
in response to determining the first audio input comprising speech has not been received, selecting a second pre-recorded video clip from among a plurality of pre-recorded video clips that does not present the local participant speaking; and
presenting the second pre-recorded video clip in place of the live video to the first video communication session.
